(19) United States
(12) Patent Application Publication
(10) Pub. No.: US 2008/0119595 A1
(43) Pub. Date: May 22, 2008

(54) FLAME RETARDANT SYNTHETIC SOLID SURFACE MATERIAL

(76) Inventors: Steve W. Waters, Buford, GA (US); Paul D. Hiltman, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 11/561,147

(22) Filed: Nov. 17, 2006

(51) Int. Cl. C08K 5/52; C08K 5/55; C08K 3/38; C08K 3/10; C08K 3/22

(52) U.S. Cl. 524/147; 524/404; 524/184; 524/406; 524/409; 524/436; 524/437

(57) ABSTRACT

A flame retardant synthetic solid surface material is disclosed which in one aspect meets stringent requirements for flammability, heat release, smoke density and toxic gas release making it suitable for commercial aircraft and similar high safety applications. The solid surface material comprises an organic resin component and a filler system comprised of at least one flame retardant substance. Also disclosed herein are methods for the manufacture of said solid surface materials and exemplary uses thereof.

### CROSS REFERENCE TO RELATED APPLICATIONS

This application claims the benefit of priority to co-pending U.S. Provisional Patent Application No. 60/737,905, filed Nov. 18, 2005, the entire disclosure of which is incorporated by reference herein for all purposes.

### FIELD OF THE INVENTION

The present invention relates generally to the field of solid surface materials and more particularly to flame retardant solid surface materials that are suitable for use in the construction of commercial airline aircraft cabin components.

### BACKGROUND OF THE INVENTION

The first solid surface material was produced in 1964 by DuPont™ Chemical Company under the tradename Corian®. It was initially developed along the lines indicated in U.S. Pat. Nos. 3,405,088 and 3,847,865 and marketed for use as countertops and paneling in residential and commercial applications. Solid surface material was an improvement over the most common prior material, high pressure plastic laminates such as Formica®, because it was more durable. Also said laminates cannot be machined to form bullnoses, splashes and sink cutouts like solid surface materials, and they cannot be repaired to remove cracks and deep scratches like solid surface materials since laminates have a non-homogeneous layered construction. Similar to laminates, solid surface material is relatively scratch and stain resistant, and capable of being cleaned with common household cleaning agents, and can be produced in a variety of colors and patterns, generally either solid color or speckled in appearance.

A significant feature of solid surface materials that are suitable for said machining and repair is the homogeneity of coloration and texture throughout the material. Because solid surface material has a consistent coloration and density of filler, it can be cut or sanded and retain its original appearance.

Currently there are many manufacturers of solid surface materials similar to Corian, but all of them have essentially the same basic composition: inorganic filler with a resin binder. The resins used are generally either acrylic or polyester base. The fillers are color pigments and solid inorganic powders and particles. While most of these materials will meet building industry codes for flammability, for example ASTM E84, there are no commercially available solid surface materials that meet the requirements for commercial aviation. The characteristics of being self-extinguishing after prolonged exposure to a flame, minimal heat and smoke release, and the absence of harmful levels of toxic gases after very high radiant and conductive thermal exposure are all requirements deemed critical for safety in the confined space of a commercial airliner. These requirements are detailed in the U.S. Code of Federal Regulations, Title 14, section 25.853 parts IV and V.

Specifically, the binding resin for all current solid surface materials are composed of an organic compound and, as such, are highly combustible. A conventional solid surface material typically relies solely on the presence of aluminum trihydrate additive to provide some degree of flammability reduction due to the breakdown of this additive at a temperature of approximately 225 degrees Celsius and subsequent release of water in the form of steam. This chemical process absorbs some of the heat being applied to the test sample plus the heat generated by the burning resin, and the water vapor tends to disrupt the oxygen supply. However the effects of this single additive typically end within the first 60 to 120 seconds, and the current test protocol as referenced previously has a duration of 300 seconds. After the aluminum trihydrate is depleted, the resin burns vigorously causing the heat release and smoke density to rise above the maximum allowable levels.

Accordingly, there is a need in the industry for a synthetic solid surface material which meets stringent requirements for flammability, heat release, smoke density and toxic gas release making it suitable for commercial aircraft and similar high safety applications.

### SUMMARY OF THE INVENTION

The present invention is based, in part, on the discovery of an organic binder resin containing solid surface material suitable for use in the construction of commercial airline cabin components.

In a first aspect, the present invention provides a solid surface material comprising at least one organic resin a filler system comprising at least one flame retardant substance. In another aspect, the solid surface material meets stringent requirements for flammability, heat release, smoke density and toxic gas release making it suitable for commercial aircraft and similar high safety applications

In a second aspect, the present invention provides an article of manufacture comprising the solid surface materials of the present invention and summarized above.

In a third aspect, the present invention provides a method for manufacturing the solid surface materials of the present invention. The method comprises providing a solid surface precursor batch composition comprising at least one organic resin and a filler system comprising at least one flame retardant substance. The precursor batch composition is then charged into a mold having a predetermined size and shape and subsequently cured under conditions effective to provide the solid surface materials of the present invention.

In still a fourth aspect, the present invention provides the product produced by the process summarized above.

In still a further aspect, the present invention provides a synthetic solid surface material comprising a brominated polyester resin; and a filler system comprised of zinc borate, antimony trioxide, alumina trihydrate, and dimethyl methylphosphonate.

Additional aspects of the invention will be set forth, in part, in the detailed description and claims which follow, and in part will be derived from the detailed description, or may be learned by practice of the invention. It is to be understood that both the foregoing general description and the following detailed description are exemplary and explanatory only and are not restrictive of the invention as disclosed or claimed.

### DETAILED DESCRIPTION OF THE INVENTION

The present invention can be understood more readily by reference to the following detailed description, examples, and claims, and their previous and following description. However, before the present compositions, devices, and/or methods are disclosed and described, it is to be understood that this invention is not limited to the specific articles, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “flame retardant” includes aspects having two or more such flame retardants unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, a “weight percent” or “percent by weight” of a component, unless specifically stated to the contrary, is based on the total weight of the formulation or composition in which the component is included.

As used herein, by use of the term “effective,” “effective amount,” or “conditions effective to” it is meant that such amount or reaction condition is capable of performing the function of the compound or property for which an effective amount is expressed. As will be pointed out below, the exact amount required will vary from one embodiment to another, depending on recognized variables such as the compounds or materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Throughout this application various publications are referenced. It should be understood that the disclosures of these publications in their entireties are hereby incorporated by reference into this application for all purposes.

In accordance with the present invention, provided is a synthetic solid surface material suitable for use in a variety of end use applications where a fire retardant, decorative, durable, wear and stain resistant solid surface is desired. The inventive material is comprised of a cured batch composition comprising at least one thermosetting organic resin and a flame retardant filler system.

The thermosetting organic resin can include any commercially available resin suitable for use in the manufacture of a synthetic solid surface material. However, in one aspect, the batch composition of the present invention comprises a flame retardant modified polyester resin. Exemplary and non-limiting modified polyester resins can include, for example, a halogenated unsaturated polyester resin that has been modified by the incorporation of one or more halogen atoms, i.e., bromine, fluorine, chlorine, iodine. An exemplary halogenated unsaturated polyester resin suitable for use in the batch composition of the present invention includes a brominated polyester resin such as, for example, the Dion® 7767-10 brominated polyester resin available from Reichold Chemical Corp. Additional halogenated polyester resins suitable for use in the inventive batch composition can include, Hetron® 92AT, 92FR or 99P available from Ashland Chemical and Vipel K022 or Firepel K130 available from AOC. In still another aspect, a suitable organic resin can include the epoxy vinyl ester class of resins, such as for example, the Hetron FR998/35 also available from Ashland Chemical.

The amount of organic resin component used to prepare the solid surface material of the present invention can be any amount that is capable of forming a synthetic solid surface material as described herein. Accordingly, in one exemplary aspect, the amount of organic resin component used can be in the range of from 5 weight % to 50 weight %, including specific weight percentages of 10, 15, 20, 25, 30, 35, 40 and 45. In still another aspect, the amount of organic resin component can be within any range derived from the above exemplified percentages, including for example, in the range of from 20% to 45%; 20% to 30%, or even 25 to 35%. Thus, it should be understood that the desired amount of organic resin component will, of course, vary depending upon circumstances such as, but not limited to, the desired application for the synthetic solid surface material. Accordingly, any optimization of the organic resin amount used will be readily obtained by one of skill in the art through routine experimentation.

In addition to the organic resin component, the synthetic solid surface material batch composition further comprises a filler system, comprising at least one flame retardant substance. As used herein, a flame retardant substance includes any substance that can be physically blended into the batch composition to suppress, reduce, delay or modify the propagation of a flame through the resulting densified solid surface material.

In one aspect, the at least one flame retardant substance can be an inorganic flame retardant. Exemplary and non-limiting inorganic flame retardants include boron containing compounds such as zinc borate; aluminum containing compounds, such as aluminum trihydrate; antimony oxides such as antimony trioxide; molybdenum containing compounds, zinc containing compounds, magnesium containing compounds such as magnesium hydroxide, and phosphorus containing compounds. In another aspect, the filler system can further comprise one or more organic flame retardants, such as a halogenated hydrocarbon and/or an organic phosphate, such as for example, dimethyl methyl phosphonate. In still a further aspect, the batch composition of the present invention can comprise a combination of organic and inorganic flame retardants such as, for example, a combination of zinc borate, antimony trioxide, aluminum trihydrate and dimethyl methyl phosphonate.

The one or more flame retardant(s) such as those exemplified above can be present in any amount capable of providing a desired level of flame retardance. For example, the amount of flame retardant can be in the range of from 1 weight % to 80 weight %, including specific exemplary amounts of 1%, 3%, 5%, 8%, 10%, 15%, 20%, 25%, 30%, 35%, 40%, 45%, 50%, 55%, 60%, 65%, 70%, and 75% relative to the total weight of the batch composition. In still a further aspect, the amount of flame retardant present in the batch composition can be within any range derived from the above stated percentages, including for example, a range of from 1% to 5%, from 5% to 10%, from 40% to 60%, or even a range of from 65% to 75%. Thus, it should be understood that the desired amount of flame retardant(s), both individually and collectively, will vary depending upon circumstances such as, but not limited to, the particular end use application for the synthetic solid surface material and the level of flame retardance desired. Accordingly, any optimization of this amount will be readily obtained by one of skill in the art through no more than routine experimentation.

In still another aspect, the filler system can comprises a plurality of flame retardants wherein at least two flame retardants have different average particle sizes. To this end, a filler system comprising a combination of a first flame retardant having a relatively fine particle size and a second flame retardant having a relatively coarse particle size can enable an increased loading or percentage of total flame retardant relative to the loading of resin component in the batch composition. More specifically, smaller particles can fill in gaps between larger particles, thereby allowing a greater displacement of resin and thus a higher filler loading percentage than would be attainable through a mixture comprised of a filler having only a single particle size. Accordingly, any of the above referenced flame retardants can be present in the filler system in a plurality of different particle sizes. However, in an exemplary aspect, the filler system of the present invention further comprises a first aluminum trihydrate flame retardant having a first average particles size in the range of from 1 to 25 microns and a second aluminum trihydrate flame retardant having an average particle size in the range of from 25 to 50 microns.

The filler system can further comprise one or more optional additives selected for their ability to impart, for example, a desired color, texture, strength, rigidity, stability, density, viscosity, porosity and/or realistic stone, i.e., marble or granite like effect to the resulting solid surface material. Exemplary additives can include colorants, pigment, magnetic material, reinforcing materials, stabilizers, fungicides, microbials, and/or minerals such as mica.

Pigment(s) suitable for use as an additive can include inorganic and/or organic pigments. The pigment(s) can be selected to impart any desired color or combination of colors into the synthetic solid surface material. Although any desired amount of pigment can be used, typically the pigment is introduced in an amount in the range of from approximately 0 weight percent to approximately 3 weight percent based upon the total weight of the batch composition, inclusive of such additional amounts as 0.1, 0.3, 0.5, 0.7, 0.9, 1.1, 1.3, 1.5, 1.7 1.9, 2.1, 2.3, 2.5, 2.7 and 2.9 weight percent. To that end, a particularly desired pigment and the optimum amount of such pigment for a given application will be readily known or obtained by one of ordinary skill in the art through no more than routine experimentation and, as such, the details thereof will not be discussed herein.

In one aspect, the filler system comprises at least one reinforcing material added to increase the strength of the cured composition. Exemplary reinforcing materials can include, without limitation, fiberglass, carbon fibers, aramid fibers, inorganic fillers, and/or refractory ceramic fibers. In an exemplary aspect, the filler system comprises a fiberglass reinforcing fiber, such as the 0.125 inch milled fiberglass fiber available from Fiberlay of Seattle, Wash., U.S.A. Although any desired amount of reinforcing material can be used, in one aspect the reinforcing material is introduced in an amount in the range of from approximately 0 weight percent to approximately 5 weight percent, based upon the total weight of the batch composition, inclusive of such exemplary amounts as 0.5 wt %, 1.0 wt %, 1.5 wt %, 2.0 wt %, 2.5 wt %, 3.0 wt %, 3.5 wt %, 4.0 wt %, and 4.5 wt %. To that end, a particularly desired reinforcing material and the optimum amount of such reinforcing material for a given application will be readily known or obtained by one of ordinary skill in the art through no more than routine experimentation and, as such, the details thereof will not be discussed herein.

The filler system, including the at least one flame retardant substance and any optional additive(s), can be present in the batch composition in any amount that is still capable of providing a synthetic solid surface material as described herein. Accordingly, in an exemplary aspect, the filler system is present in an amount in the range of from 50 weight % to 95 weight %, including exemplary amounts of 55%, 60%, 65%, 70, 75, 80, 85 and 90%. In still another aspect, the filler system can be in an amount within any range derived from the above exemplified percentages, including for example, an amount in the range of from 60% to 80%; from 65% to 75%, or even 60% to 90%. Thus, it should be understood that the desired amount of filler system will, of course, vary depending upon circumstances such as, but not limited to, the desired level of flame retardance and desired aesthetic properties such as opacity, transparency, color and/or texture. Accordingly, any optimization of this amount will be readily obtained by one of skill in the art through no more than routine experimentation.

To prepare the synthetic solid surface material batch composition, the resin component(s) and filler system, including the at least one flame retardant and any optional additives such as pigment and the like, are combined and blended by any suitable means to provide a substantially homogenous precursor batch composition. For example, dry ingredients such as flame retardant; pigment, resin chips, and the like, can first be blended to provide a homogenous dry batch premix. The dry batch premix can then be blended together with any liquid ingredients, such as for example a liquid resin component. In still a further aspect, it can be desired to perform the mixing steps in a conventional vacuum mixer in order to de-gas the batch composition and to prevent undesired aeration of the batch composition prior to curing. Additionally, as one of skill in the art will appreciate, mixing under vacuum can also act to improve the wetting of the dry or powdered batch components by the liquid resin component.

An exemplary non-limiting batch composition prepared in accordance with the present invention can comprise approximately 20 to 40% by weight of the resin component and approximately 60% to 80% by weight of the filler system. In further accordance with this aspect of the present invention, an exemplary batch composition can comprise from 24 to 32 weight % brominated polyester resin; from 7 weight % to 11 weight % zinc borate; from 7 weight % to 11 weight % antimony trioxide; from 43 weight % to 53 weight % aluminum trihydrate; and from 3 weight % to 5 weight % dimethyl methylphosphonate.

A polymerization catalyst or mixture of polymerization catalysts is also introduced into the precursor batch composition to initiate the polymerization of the resin component. Any catalyst suitable for use in initiating the cross linking reaction of the thermosetting resin composition and in turn the curing of the precursor composition can be used. Such catalysts are well recognized in the art and typically are based on an organic peroxide type compound such as, for example, methyl ethyl ketone peroxide, benzoyl peroxide, tertiary butyl hydroperoxide, and the like. Typically, the catalyst may be present in amounts ranging from about 0.1 to about 5 percent by weight of the precursor batch composition.

After incorporation of the catalyst, the resulting precursor batch composition and catalyst can then be charged into a suitable mold apparatus for curing and producing a final casting having a desired size and shape. While any conventional casting mold can be used, in one aspect a suitable mold can be configured in a flat outline style in order to form a casting having a constant horizontal cross section. Often it is desired to sand or mill a resulting casting on one or both sides in order to remove a skin layer that may not posses a desired uniform coloration. Thus, by providing a casting having a substantially horizontal cross section, it can facilitate the sanding or machining of the resulting casting.

The synthetic solid surface material precursor batch composition can be cured under any conditions effective for providing a cured synthetic solid surface material. In one aspect, the batch composition can be cured at room temperature as a result of the catalyst initiating the cross linking reaction with the thermosetting resin. However, it should be appreciated that in order to speed up the curing process, a mold charged with the precursor batch composition can also be cured at elevated temperatures above room or ambient in order to speed the curing time. As such, in another aspect, the castings can be cured by any known means for increasing the temperature above ambient conditions, including for example, infra-red, radiant, heated mold, conductive and/or convective heat processes.

The inventive solid surface materials of the present invention can be molded, cast, sanded, machined, or otherwise formed into any desired size and shape and are thus well suited for use in a number of articles of manufacture. For example, and without limitation, the solid surface materials of the present invention can be cast into articles suitable for use as vanity tops, countertops, residential and commercial furniture, window sills and thresholds, wall panels, wainscoting, backsplashes, baseboards and even bath and shower enclosures.

However, in a further aspect, a synergistic effect of the component materials in the solid surface material provides a sequential protective mechanism during extreme heat exposure. Thus, in accordance with this aspect of the present invention, the solid surface materials of the present invention can exhibit a unique combination of mechanical, chemical, flammability and thermal resistance properties that satisfy the rigid acceptance criteria legislatively mandated for use in the commercial airline applications worldwide. Accordingly, the solid surface materials of the present invention can be used to manufacture countertops, flooring, shelving, galleys and other related elements for aircraft and similar safety-sensitive applications.

The characteristics of being self-extinguishing after prolonged exposure to a flame and exhibiting a minimal level of heat and smoke release are all requirements deemed critical for safety in the confined space of a commercial airliner. These requirements can be evaluated according to the Vertical Burn Test, Heat Release Test, and Smoke Density Tests, respectively, each of which is detailed in the U.S. Code of Federal Regulations, Title 14, sections 25.853 and 25.855, the entire disclosure of which is also incorporated by reference for all purposes.

### Vertical Burn Test

The Vertical Burn Test is used to evaluate the flammability of a subject material by monitoring the effects of prolonged exposure to a flame. The testing protocol as set forth in Part I of Appendix F to 14 C.F.R. section 25 states that a minimum of three specimens should be tested and results averaged. The test specimens are tested either as a section cut from a fabricated part as installed in the airplane or as a specimen simulating a cut section, such as a specimen cut from a flat sheet of the material or a model of the fabricated part. The specimen may be cut from any location in a fabricated part; however, fabricated units, such as sandwich panels, may not be separated for test. Except as noted below, the specimen thickness should be no thicker than the minimum thickness to be qualified for use in the airplane. Specimens should also be mounted in a metal frame so that the two long edges and the upper edge are held securely during the Vertical Burn Test. The exposed area of the specimen should be at least 2 inches wide and 12 inches long, unless the actual size used in the airplane is smaller. The edge to which the burner flame is applied should not consist of the finished or protected edge of the specimen but should be representative of the actual cross-section of the material or part as installed in the airplane.

Each specimen, prepared as set forth above, is then supported vertically and exposed to a Bunsen or Tirrill burner with a nominal ⅜-inch I.D. tube adjusted to give a flame of 1½ inches in height. The minimum flame temperature measured by a calibrated thermocouple pyrometer in the center of the flame should be 1550° F. The lower edge of the specimen should be ¾-inch above the top edge of the burner. The flame should be applied to the center line of the lower edge of the specimen. The flame should be applied for 60 seconds and then removed. Flame time, burn length, and flaming time of drippings, if any, are then recorded. The burn length should be measured to the nearest tenth of an inch. To that end, the burn length is defined as the distance from the original edge to the farthest evidence of damage to the test specimen due to flame impingement, including areas of partial or complete consumption, charring, or embrittlement, but not including areas sooted, stained, warped, or discolored, nor areas where material has shrunk or melted away from the heat source.

Current federal regulations stipulate that in order to satisfy the acceptance criteria of the Vertical Burn Test, the average burn length can not exceed 6 inches; the average flame time after removal of the flame source cannot exceed 15 seconds; and any drippings from the test specimen cannot continue to flame for more than an average of 3 seconds after dripping. To that end, in one aspect of the present invention, the synthetic solid surface materials described herein exhibit a limited flammability profile that meets or exceeds the Vertical Burn Test acceptance criteria set forth above.

Specifically, when tested according to the Vertical Burn Test procedure set forth above, the solid surface materials of the present invention exhibit an average burn length that does not exceed 6 inches. In one aspect the average burn length is less than 6 inches, including burn lengths of less than 5.5 inches, less than 5.0 inches, less than 4.5 inches, less than 4.0 inches, less than 3.5 inches, less than 3.0 inches, less than 2.5 inches, less than 2.0 inches, less than 1.5 inches, and even less than 1.0 inches. In still another aspect, the solid surface material of the present invention exhibits an average burn length in a range derived from any of the aforementioned burn length values.

In further accordance with the acceptance criteria of the Vertical Burn Test, the solid surface materials of the present invention do not exhibit an average after flame time exceeding 15 seconds. To this end, in another aspect, the average after flame time of the inventive materials can be less than 15, 14, 13, 12, 11, 10, 9, 8, 7, 6, 5, 4, 3, 2, or even less than 1 second. In still another aspect, the solid surface materials of the present invention can exhibit an average after flame time in any range derived from the aforementioned after flame time values.

With respect to the average flame time of drippings resulting from the inventive solid surface materials disclosed herein, in one aspect, the solid surface materials exhibit an average after flame time of drippings that does not exceed 3 seconds. In still another aspect, the solid surface materials exhibit an average after flame time of drippings that is less than 3 seconds, including after flame time of drippings that are less than 2 seconds or even less than 1 second. In still another aspect, the solid surface materials of the present invention are at least substantially free of any drippings resulting from the Vertical Burn Test described herein.

### Heat Release Test

The Heat Release Test is used to evaluate the amount of heat released and the rate of said heat release from a subject material exposed to radiant heat. The testing protocol for the Heat Release Test is set forth in Part IV of Appendix F to 14 C.F.R. section 25, the entire disclosure of which is incorporated herein by reference.

Under this test, the total positive heat release over the first two minutes of exposure for each of the three or more samples tested should be averaged, and the peak heat release rate for each of the samples should be averaged. To this end, current regulations stipulate that in order to satisfy the acceptance criteria of the Heat Release Test, the average total heat release should not exceed 65 kilowatt-minutes per square meter, and the average peak heat release rate should not exceed 65 kilowatts per square meter.

Accordingly, the solid surface materials of the present invention in one aspect exhibit an average total positive heat release that does not exceed 65 kW min/m². In another aspect, the solid surface material of the present invention exhibits an average total positive heat release that is less than 65 kW min/m², including average total positive heat release values less than 60 kW min/m², less than 55 kW min/m², less than 50 kW min/m², less than 45 kW min/m², less than 40 kW min/m², less than 35 kW min/m², less than 30 kW min/m², or even less than 25 kW min/m². In still another aspect, the solid surface materials of the present invention exhibit an average total positive heat release in a range derived from any of the aforementioned heat release values.

In further accordance with the acceptance criteria of the Heat Release Test, the solid surface materials of the present invention can, in one aspect, further exhibit an average maximum heat release rate that does not exceed 65 kW/m². Thus, in one aspect, the solid surface material of the present invention exhibits an average maximum heat release rate that is less than 65 kW/m², including average maximum heat release rates of less than 60 kW/m², less than 55 kW/m², less than 50 kW/m², less than 45 kW/m², less than 40 kW/m², less than 35 kW/m², less than 30 kW/m², or even less than 25 kW/m². In still another aspect, the solid surface materials of the present invention exhibit an average peak heat release rate in a range derived from any of the aforementioned heat release values.

### Smoke Density Test

The Smoke Density Test is the test method used to evaluate the smoke emission characteristics of certain aircraft cabin materials. The specific testing protocol corresponds to the ASTM F814-83 test procedure and is set forth in Part V of Appendix F to 14 C.F.R. § 25, the entire disclosure of which is incorporated herein by reference.

According to current test procedures and acceptance criteria, the specific optical smoke density (D_{S}), which is obtained by averaging the reading obtained after 4 minutes with each of three specimens, shall not exceed 200. To this end, in one aspect, the solid surface materials of the present invention, when tested pursuant to the Smoke Density Test referenced above, exhibit a maximum optical smoke density that does not exceed 200. In still another aspect, the solid surface materials of the present invention exhibit a maximum optical smoke density less than 200, including optical smoke densities less than 190, less than 180, less than 170, less than 160, less than 150, less than 140, less than 130, less than 120, less than 110, and even less than 100.

### Toxic Gas Release Test

The Toxic Gas Release Test is the protocol used for evaluating the concentration of toxic gases present in a sampling of gases emitted from a subject material. The specific testing procedures are set forth in Airbus Industries Fireworthiness Standards section 7-4 (the entire disclosure of which is incorporated herein by reference) and is referred to herein as the Airbus Industries Testing Method (AITM) 3.0005.

Specifically, the Toxic Gas Release Test evaluates the release of hydrogen fluoride, hydrogen chloride, hydrogen cyanide, sulfur dioxide, nitrous gases, and carbon monoxide. To that end, the acceptance criteria for the Toxic Gas Release Test stipulates that a subject material cannot release: (1) a concentration of released hydrogen fluoride gas that exceeds 100 ppm; (2) a concentration of released hydrogen chloride gas that exceeds 150 ppm; (3) a concentration of released hydrogen cyanide gas that exceeds 150 ppm; (4) a concentration of released sulfur dioxide gas that exceeds 100 ppm; (5) a concentration of released nitrous gases that exceeds 100 ppm; and (6) a concentration of released carbon monoxide gas that exceeds 1000 ppm.

Accordingly, in still another aspect, the solid surface materials of the present invention meet or even exceed the acceptance criteria of the Toxic Gas Release Test set forth above. More specifically, in one aspect, the solid surface materials of the present invention do not release a concentration of hydrogen fluoride gas that exceeds 100 ppm. To this end, in another aspect, the concentration of released hydrogen fluoride gas is less than 100 ppm, including concentrations that are less than 90 ppm, less than 80 ppm, less than 70 ppm, less than 60 ppm, less than 50 ppm, less than 40 ppm, less than 30 ppm, less than 20 ppm, less than 10 ppm and even less than 5 ppm.

In another aspect, the solid surface materials of the present invention do not release a concentration of hydrogen chloride gas that exceeds 150 ppm. To this end, the concentration of released hydrogen chloride gas can, in one aspect, be less than 150 ppm, including concentrations that are less than 140 ppm, less than 100 ppm, less than 70 ppm, less than 60 ppm, less than 50 ppm, less than 40 ppm, less than 30 ppm, less than 20 ppm, less than 10 ppm and even less than 5 ppm.

In further accordance with the Toxic Gas Release Test, the solid surface materials of the present invention do not release a concentration of hydrogen cyanide gas that exceeds 150 ppm. To this end, the concentration of released hydrogen cyanide gas can, in one aspect, be less than 150 ppm, including concentrations that are less than 140 ppm, less than 100 ppm, less than 70 ppm, less than 60 ppm, less than 50 ppm, less than 40 ppm, less than 30 ppm, less than 20 ppm, less than 10 ppm and even less than 5 ppm.

In still another aspect, the solid surface materials of the present invention do not release a concentration of sulfur dioxide gas that exceeds 100 ppm. To this end, in another aspect, the concentration of released sulfur dioxide gas is less than 100 ppm, including concentrations that are less than 90 ppm, less than 80 ppm, less than 70 ppm, less than 60 ppm, less than 50 ppm, less than 40 ppm, less than 30 ppm, less than 20 ppm, less than 10 ppm and even less than 5 ppm.

In still another aspect, the solid surface materials of the present invention do not release a concentration of nitrous gases (NOₓ) that exceeds 100 ppm. To this end, in another aspect, the concentration of released nitrous gases can be less than 100 ppm, including concentrations that are less than 90 ppm, less than 80 ppm, less than 70 ppm, less than 60 ppm, less than 50 ppm, less than 40 ppm, less than 30 ppm, less than 20 ppm, less than 10 ppm and even less than 5 ppm.

Further, in yet another aspect and pursuant to the procedures of the Toxic Gas Release Test, the solid surface materials of the present invention do not release a concentration of carbon monoxide that exceeds 1000 ppm. To this end, in another aspect, the concentration of released carbon monoxide gas can be less than 1000 ppm, including concentrations that are less than 900 ppm, less than 800 ppm, less than 700 ppm, less than 600 ppm, less than 500 ppm, less than 400 ppm, less than 300 ppm, less than 200 ppm, less than 100 ppm and even less than 50 ppm.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein.

### EXAMPLES

The following example, including any experimental data, is put forth so as to provide those of ordinary skill in the art with a complete disclosure and description of how the synthetic solid surface material of the present invention can be made, used and/or evaluated. These examples are intended to be purely exemplary of the invention and are not intended to limit the scope of what is encompassed within the spirit and scope of the invention. Efforts have been made to ensure accuracy with respect to numbers (e.g., amounts, temperature, etc.) However, some errors and deviations should be accounted for. Unless indicated otherwise, parts are parts by weight, temperature is in ° C. or is at ambient temperature, and pressure is at or near atmospheric.

An exemplary solid surface material precursor batch composition was prepared according to the formulation set forth below in Table 1.

TABLE 1

| Ingredient | Tradename | Manufacture | Wt. % |
|---|---|---|---|
| Aluminum Trihydrate (fine) | Onxy Elite | J. M Huber | 31.41% |
| Aluminum Trihydrate (medium) | Onyx Elite | J. M. Huber | 11.22% |
| Aluminum Trihydrate (filled polyester) | Densified Chip - green | R. J. Marshall | 0.90% |
| Aluminum Trihydrate (filled polyester) | Densified Chip - black | R. J. Marshall | 4.49% |
| Aluminum Trihydrate (filled polyester) | Densified Chip - white | R. J. Marshall | 2.69% |
| Zinc Borate | Firebrake ZB | Borax Corp. | 8.98% |
| Antimony Trioxide | Antimony Trioxide | ICC Chemical | 8.98% |
| Dry Pigment Powder A | Universal Runnel Green | Caddo Paint Co., Inc. | 0.90% |
| Dry Pigment Powder B | Velvet Green | Caddo Paint Co., Inc. | 0.07% |
| Dimethyl Methyl Phosphonate | Fyrol DMMP | Supresta LLC | 3.88% |
| Liquid Brominated Polyester Resin | Dion 7767-10 | Reichold Chemical Corp. | 25.88% |
| Methyl ethyl ketone peroxide | Luperox | Atofina Chemicals, Inc. | 0.65% |

Each of the dry ingredients were first added to a dry mixer bucket and subsequently blended for approximately 6 minutes. The resulting dry mix was then transferred into a sealed container. All liquid components of the formulation except for the methyl ethyl ketone peroxide catalyst were then charged into a vacuum mixer. Following the liquid addition, the previously prepared dry mix was charged into the vacuum mixer as well. After a period of hand blending, the resulting batch composition was placed under a vacuum pressure of approximately 22 in.Hg and mixed for a period of approximately 10-12 minutes. Following this vacuum mixing period, the vacuum was removed and the mixer sides and paddle were scraped to ensure a more homogenous batch composition. After scraping, the batch composition was again placed under a vacuum pressure of approximately 22 in.Hg and mixed for another period of approximately 10-12 minutes.

Following the second vacuum mixing period, the vacuum was removed and the mixer lid was opened in order to charge the appropriate amount of methyl ethyl ketone peroxide catalyst into the mixer. Following this catalyst addition, the resulting batch composition and catalyst were mixed in the vacuum mixer under a vacuum pressure of approximately 22 in.Hg for an initial period of approximately 3-5 minutes. Following this vacuum mixing period, the vacuum was again removed and the mixer sides and paddle were again scraped to ensure a more homogenous batch composition and catalyst mixture. After scraping, the batch composition and catalyst mixture were again placed under a vacuum pressure of approximately 22 in.Hg and mixed for another period of approximately 3-5 minutes.

Following the second 3-5 minute mixing period, the batch composition and catalyst mixture was charged into an appropriate mold configure to provide a casting having a constant horizontal cross section. After the batch composition was charged into the mold, the batch composition was then allowed to begin curing at ambient conditions. Once the composition within the mold was hard to the touch, the mold was placed into a convection oven at an average temperature of 180° F. for 90 to 150 minutes. The mold was then removed from the oven and allowed to cool to room temperature. Once cooled, the resulting synthetic solid surface material was removed from the mold and appropriate specimens were prepared for conducting the Vertical Burn Test, Heat Release Test, Smoke Density Test, and Toxic Gas Release Test, according to the testing procedures described above. The results of these tests are set forth in Tables 2-5 below:

TABLE 2
Vertical Burn Test

| | |
|---|---|
| After flame (duration of sample) | 0 seconds |
| Burn length | 0.75 inches |
| After flame (duration of drippings) | No drippings occurred |

TABLE 3
Heat Release Test

| | |
|---|---|
| Average Peak Heat Release Rate | 60.0 kW/m² |
| Average total Heat Release | 30.3 kW min/m² |

TABLE 4
Smoke Density Test

| | |
|---|---|
| Average peak smoke density | 107 |

TABLE 5
Toxic Gas Release Test

| | Gas Tested | | | | | |
|---|---|---|---|---|---|---|
| | HCN | CO | NOₓ | SO₂ | HF | HCL |
| Sample 1 | <4 | 286 | <8 | <9 | <12 | <8 |
| Sample 2 | <5 | 310 | <10 | <9 | <10 | <9 |
| Average | <5 | <298 | <10 | <9 | <12 | <9 |
| Max Allowed | 150 | 1000 | 100 | 100 | 100 | 150 |
| Comment | Pass | Pass | Pass | Pass | Pass | Pass |

What is claimed is:

1. A solid surface material, comprising
a) at least one organic resin; and
b) a filler system comprising at least one flame retardant;
wherein the solid surface material exhibits a Vertical Burn Test flammability profile comprising an average after burn length that does not exceed 6 inches, an average after flame time that does not exceed 15 seconds, and an average after flame time of drippings that does not exceed 3 seconds;
wherein the solid surface material exhibits a Heat Release Test profile comprising an average total positive heat release that does not exceed 65 kW min/m² and an average maximum heat release rate that does not exceed 65 kW/m²; and
wherein the solid surface material exhibits a maximum optical smoke density less than or equal to 200 when tested according to ASTM F814-83.

2. The solid surface material of claim 1, wherein the solid surface material exhibits a Toxic Gas Release Test profile when tested according to AITM 3.0005 comprising:
i. a concentration of released hydrogen fluoride gas that does not exceed 100 ppm;
ii. a concentration of released hydrogen chloride gas that does not exceed 150 ppm;
iii. a concentration of released hydrogen cyanide gas that does not exceed 150 ppm;
iv. a concentration of released sulfur dioxide gas that does not exceed 100 ppm;
v. a concentration of released nitrous gases that does not exceed 100 ppm; and
vi. a concentration of released carbon monoxide gas that does not exceed 1000 ppm.

3. The solid surface material of claim 1, comprising:
a) from 20 to 40 percent by weight of the organic resin; and
b) from 60 to 80 percent by weight of the filler system;
wherein the total weight percentage of components a) and b) does not exceed 100 percent.

4. The solid surface material of any of claim 1-3, wherein the organic resin is a polyester resin.

5. The solid surface material of claim 4 wherein the polyester resin is unsaturated.

6. The solid surface material of claim 4 wherein the polyester resin is halogenated.

7. The solid surface material of claim 6 wherein the polyester resin is brominated.

8. The solid surface material of claim 1, wherein the filler system comprises at least one inorganic flame retardant.

9. The solid surface material of claim 8, wherein the at least one inorganic flame retardant comprises a boron containing compound, antimony oxide, molybdenum containing compound, zinc containing compound, magnesium containing compound, phosphorus containing compound, aluminum containing compound, or any combination thereof.

10. The solid surface material of claim 9, wherein the filler system comprises zinc borate.

11. The solid surface material of claim 10, wherein the filler system comprises antimony trioxide.

12. The solid surface material of claim 11, wherein the filler system further comprises aluminum trihydrate.

13. The solid surface material of claim 1, wherein the filler system comprises an organic flame retardant.

14. The solid surface material of claim 13, wherein the organic flame retardant comprises a phosphorus containing compound.

15. The solid surface material of claim 14, wherein the organic flame retardant comprises dimethyl methyl phosphonate.

16. The solid surface material of claim 12, wherein the filler comprises a mixture of a first aluminum trihydrate having a first average particle size and a second aluminum trihydrate having a second average particle size.

17. The solid surface material of claim 1, wherein the filler system further comprises a colorant.

18. The solid surface material of claim 17, wherein the colorant comprises at least one pigment.

19. The solid surface material of claim 1, further comprising a polymerization catalyst.

20. The solid surface material of claim 19, wherein the polymerization catalyst comprises methyl ethyl ketone peroxide.

21. An article of manufacture comprising the solid surface material of claim 1.

22. The article of manufacture of claim 21, wherein the article is interior aircraft element.

23. The article of manufacture of claim 22, wherein the interior aircraft element is a counter top.

24. The solid surface material of claim 1, further comprising at least one reinforcing material.

25. The solid surface material of claim 24, wherein the at least one reinforcing material comprises fiberglass.

26. The solid surface material of claim 24, wherein the reinforcing material is present in an amount of from great than 0 weight % to 5 weight percent.

27. A method for the manufacture of a solid surface material, comprising the steps of:
a) providing a solid surface material precursor batch composition comprising at least one organic resin; and a filler system comprising at least one flame retardant;
b) charging the solid surface precursor batch composition into a mold having a predetermined size and shape; and
c) curing the solid surface precursor batch composition in the mold under conditions effective to provide a solid surface material,
wherein the solid surface material exhibits a Vertical Burn Test flammability profile comprising an average after burn length that does not exceed 6 inches, an average after flame time that does not exceed 15 seconds, and an average after flame time of drippings that does not exceed 3 seconds;
wherein the solid surface material exhibits a Heat Release Test profile comprising an average total positive heat release that does not exceed 65 kW min/m² and an average maximum heat release rate that does not exceed 65 kW/m²; and
wherein the solid surface material exhibits a maximum optical smoke density less than or equal to 200 when tested according to ASTM F814-83.

28. The method of claim 27, wherein the solid surface material further exhibits a Toxic Gas Release Test profile when tested according to AITM 3.0005 comprising:
i. a concentration of released hydrogen fluoride gas that does not exceed 100 ppm;
ii. a concentration of released hydrogen chloride gas that does not exceed 150 ppm;
iii. a concentration of released hydrogen cyanide gas that does not exceed 150 ppm;
iv. a concentration of released sulfur dioxide gas that does not exceed 100 ppm;
v. a concentration of released nitrous gases that does not exceed 100 ppm; and
vi. a concentration of released carbon monoxide gas that does not exceed 1000 ppm.

29. The method of claims 27, wherein the solid surface batch composition comprises:
a) from 20 to 40 percent by weight of the organic resin; and
b) from 60 to 80 percent by weight of the filler system,
wherein the total weight percentage of components a) and b) does not exceed 100 percent.

30. The method of claim 27, wherein the organic resin is a polyester resin.

31. The method of claim 30, wherein the polyester resin is unsaturated.

32. The method of claim 30, wherein the polyester resin is halogenated.

33. The method of claim 32, wherein the polyester resin is brominated.

34. The method of claim 27, wherein the filler system comprises at least one inorganic flame retardant.

35. The method of claim 34, wherein the filler system comprises a boron containing compound, antimony oxide, molybdenum containing compound, zinc containing compound, magnesium containing compound, phosphorus containing compound, aluminum containing compound, or any combination thereof.

36. The method of claim 35, wherein the filler system comprises zinc borate.

37. The method of claim 36, wherein the filler system comprises antimony trioxide.

38. The method of claim 37, wherein the filler comprises at least one aluminum trihydrate

39. The method of claim 38, wherein the filler system comprises a first aluminum trihydrate having a first average particle size and a second aluminum trihydrate having a second average particle size.

40. The method of claim 27, wherein the filler system comprises an organic flame retardant.

41. The method of claim 40, wherein the organic flame retardant comprises a phosphorus containing compounds.

42. The method of claim 41, wherein the organic flame retardant comprises dimethyl methyl phosphonate.

43. The method of claim 27, wherein the filler system comprises a colorant.

44. The method of claim 43, wherein the colorant comprises at least one pigment.

45. The method of claim 27, wherein the batch composition further comprises a polymerization catalyst.

46. The method of claim 45, wherein the polymerization catalyst comprises methyl ethyl ketone peroxide.

47. A solid surface material produced by the method of claim 27.

48. A synthetic solid surface material comprising:
a) a brominated polyester resin; and
b) a filler system comprised of zinc borate, antimony trioxide, alumina trihydrate, and dimethyl methylphosphonate.

49. The synthetic solid surface material of claim 48 wherein said resin is an unsaturated polyester.

50. The synthetic solid surface material of claims 48, wherein the filler system further comprises at least one color pigment.

51. The synthetic solid surface material of claim 48, wherein the filler system comprises one or more nonflammable decorative inorganic materials.

52. The synthetic solid surface material of claim 51, wherein the nonflammable decorative material comprises mica.

53. The synthetic solid surface material of claim 48, comprising:
a) from 20 weight % to 40% of the brominated polyester resin; and
b) from 60 weight % to 80 weight % of the filler system.

54. The synthetic solid surface material of claim 48, comprising:
(a) from 24 weight % to 32 weight % brominated polyester resin;
(b) from 7 weight % to 11 weight % zinc borate;
(c) from 7 weight % to 11 weight % antimony trioxide;
(d) from 43 weight % to 53 weight % aluminum trihydrate; and
(e) from 3 weight % to 5 weight % dimethyl methylphosphonate.

55. The synthetic solid surface material according to claim 48, wherein the alumina trihydrate is comprised of a mixture of a first aluminum trihydrate having a first average particle size and a second aluminum trihydrate having a second average particle size.
